(19) United States
(12) Patent Application Publication
(10) Pub. No.: US 2024/0362840 A1
(43) Pub. Date: Oct. 31, 2024

(54) GANTT CHART GENERATION DEVICE, GANTT CHART GENERATION METHOD, AND MEDIUM STORING PROGRAM

(71) Applicant: Mitsubishi Electric Corporation, Tokyo (JP)

(72) Inventor: Ryo MATSUMURA, Tokyo (JP)

(73) Assignee: Mitsubishi Electric Corporation, Tokyo (JP)

(21) Appl. No.: 18/763,631

(22) Filed: Jul. 3, 2024

Related U.S. Application Data
(63) Continuation of application No. PCT/JP2022/003935, filed on Feb. 2, 2022.

(51) Int. Cl. G06T 11/20; G06F 3/14; G06T 5/50

(52) U.S. Cl. CPC G06T 11/206; G06F 3/14; G06T 5/50; G06T 2207/20221

(57) ABSTRACT

The Gantt chart generation device 1 includes: an acquisition unit to acquire plan information showing processes for carrying out a desired plan, resources, and a schedule for processing the processes, and change information showing quantities changing in time series in accordance with the processing; a Gantt chart generation unit to generate a Gantt chart showing, for each of the resources, the processes to be processed by the resources, and the schedule based on the plan information; a change image generation unit to generate change images showing, for each of the resources, the quantities changing in time series in accordance with the processing based on the change information; a superimposition unit to superimpose the change images on corresponding areas to the resources and the times on the Gantt chart; and a display control unit to display, on a display device, the Gantt chart on which the change images are superimposed.

### CROSS-REFERENCE TO RELATED APPLICATION

This application is a Continuation of PCT International Application No. PCT/JP2022/003935, filed on Feb. 2, 2022, which is hereby expressly incorporated by reference into the present application.

### TECHNICAL FIELD

The present invention relates to a Gantt chart generation device, a Gantt chart generation method, and a medium storing a program.

### BACKGROUND TECHNOLOGY

Conventionally, information used for carrying out a desired plan in project, production, development, etc. has sometimes been visualized using a Gantt chart (hereinafter such information is referred to as plan information). The plan information includes information about multiple processes, a sequence to process the processes, resources (operator and/or apparatus) to process each process, and a schedule (start date, end date and/or number of days) to process each process for carrying out of the desired plan.

Patent Document 1 discloses a technique for visualizing information used to carry out a plan for manufacturing a product using a Gantt chart. Patent Document 1 also describes that the operator can change an originally planned schedule by dragging a planning bar showing the originally planned schedule to a desired location on the Gantt chart.

### PRIOR ART REFERENCES

### Patent Documents

[Patent Document 1] Japanese Patent Application Laid-Open No. 2005-063084

### SUMMARY OF THE INVENTION

### Problems to be Solved by the Invention

Meanwhile, when creating and/or modifying a Gantt chart, it is necessary for the operator to check not only the plan information, but also, for example, information about resources that changes in time series and affects the carrying out of the desired plan, such as operating statuses of the resources and inventory statuses of materials to be used and/or consumed by the resources (hereinafter referred to as change information). However, according to the technique disclosed in Patent Document 1, when creating and/or modifying a Gantt chart, the operator has to check each and every change information outputted independently of the Gantt chart. Therefore, the challenge with the technique disclosed in Patent Document 1 is that the work of creating and/or modifying a Gantt chart is cumbersome for the operator.

The present disclosure has been made to solve the aforementioned problem and is intended to reduce the cumbersomeness for the operator with the work of creating and/or modifying a Gantt chart.

### Means for Solving the Problems

A Gantt chart generation device includes: an acquisition unit to acquire plan information showing processes for carrying out a desired plan, resources for processing the processes, and time periods for processing the processes, and change information showing quantities changing in accordance with the processing of the resources for each of the time periods, the change information being to affect the carrying out of the desired plan; a Gantt chart generation unit to generate a Gantt chart showing, for each of the resources and the time periods, the processes processed by the resource in the time period on a basis of the plan information acquired by the acquisition unit; a change image generation unit to generate change images showing, for each of the resources and the time periods, the quantities changing in accordance with the processing of the resources on a basis of the change information acquired by acquisition unit; a superimposition unit to superimpose the change images generated by the change image generation unit on corresponding areas to the resources and the time periods on the Gantt chart; and a display control unit to display the Gantt chart on which the change images are superimposed by the superimposition unit on a display device, wherein the change information shows scheduled carbon dioxide emissions of the resources, scheduled power consumption of the resources, or scheduled water consumption of the resources.

### Effects of the Invention

The present disclosure reduces the cumbersomeness for the operator with the work of creating and/or modifying a Gantt chart.

### BRIEF DESCRIPTION OF DRAWINGS

FIG. 1 is a diagram showing an example of a management system including a Gantt chart generation device according to Embodiment 1.

FIG. 2 is a diagram showing an example of the Gantt chart generated on the basis of plan information.

FIG. 3 is a diagram showing an example of the Gantt chart with change images superimposed.

FIG. 4 is a flowchart diagram showing operation of the Gantt chart generation device.

FIG. 5 is a diagram showing an example of a management system including a Gantt chart generation device according to Embodiment 2.

FIG. 6 is a diagram showing an example of the Gantt chart with in-process images superimposed.

FIG. 7 is a diagram showing an example of a management system including a Gantt chart generation device according to Embodiment 3.

FIG. 8 is a diagram showing an example of the Gantt chart with an achievement image superimposed.

FIG. 9 is a diagram showing an example of the Gantt chart with an achievement image superimposed.

FIG. 10 is a diagram showing an example of the Gantt chart with achievement images superimposed.

### EMBODIMENTS FOR CARRYING OUT THE INVENTION

The following is a detailed description, based on drawings, of a Gantt chart generation device 1 according to the embodiments of the present disclosure. However, the present disclosure is not limited to the embodiments described below.

### Embodiment 1

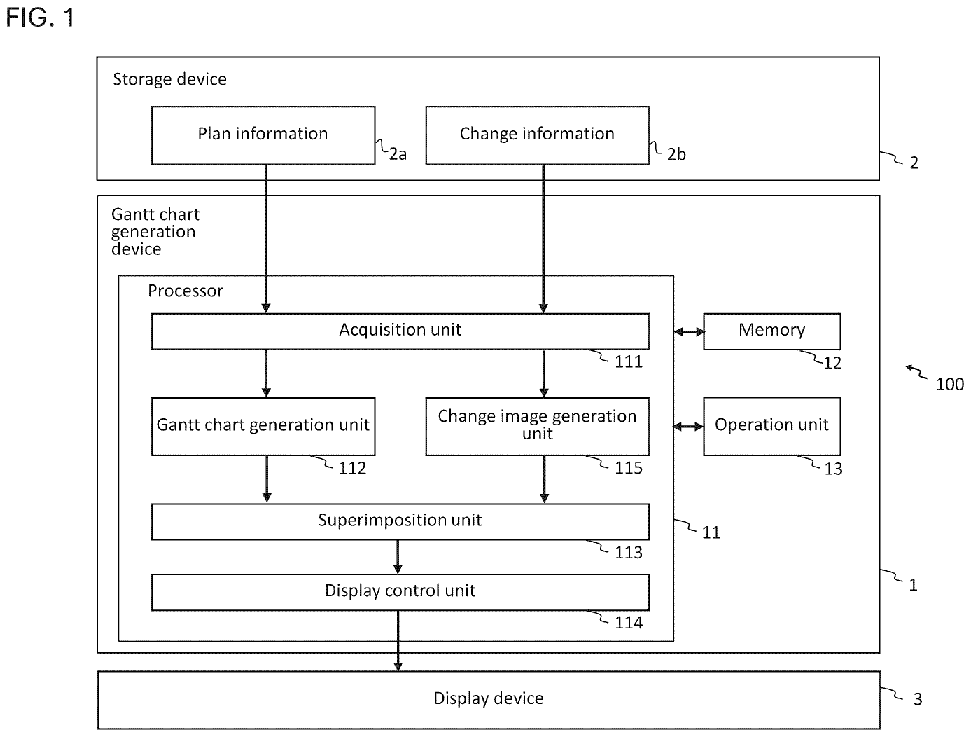

FIG. 1 shows an example of a management system 100 including a Gantt chart generation device 1 according to Embodiment 1. The management system 100 includes a Gantt chart generation device 1, a storage device 2, and a display device 3. The storage device 2 is a storage area provided on a network that is not shown. The storage device 2 stores plan information 2a and change information 2b, which will be described later. The Gantt chart generation device 1 superimposes change images generated on the basis of the change information 2b on a Gantt chart generated on the basis of the plan information 2a acquired from the storage device 2. The display device 3 is, for example, a display showing a Gantt chart on which the change images outputted from the Gantt chart generation device 1 are superimposed. The Gantt chart generation device 1 reduces the cumbersomeness for an operator with the work of creating and/or modifying Gantt charts by displaying, on the display device 3, the Gantt chart on which the change images are superimposed.

The Gantt chart generation device 1 includes a processor 11, a memory 12, and an operation unit 13. The operation unit 13 is, for example, a mouse or a keyboard for accepting operations from a user. The Gantt chart generation device 1 may be configured to operate with an externally provided operating unit 13. The memory 12 is, for example, a Dynamic Random Access Memory (DRAM) that serves as a primary storage device. For example, the memory 12 temporarily stores a program to be executed by the processor 11. The processor 11 is, for example, a Central Processing Unit (CPU), which executes a program to process data and output the processed data. By executing a program, the processor 11 performs functions of an acquisition unit 111, a Gantt chart generation unit 112, a change image generation unit 115, a superimposition unit 113, and a display control unit 114.

The acquisition unit 111 acquires the plan information 2a and the change information 2b from the storage device 2. The Gantt chart generation unit 112 generates a Gantt chart based on the plan information 2a acquired by the acquisition unit 111. The change image generation unit 115 generates change images based on the change information 2b acquired by the acquisition unit 111. The superimposition unit 113 superimposes the change images generated by the change image generation unit 115 on the Gantt chart generated by the Gantt chart generation unit 112. The display control unit 114 displays, on the display device 3, the Gantt chart on which the change image is superimposed by the superimposition unit 113.

### About the Plan Information 2a Stored in the Storage Device 2

The plan information 2a includes information that is referenced in project, production, development, etc. for carrying out a desired plan. Specifically, the plan information 2a includes, but not limited to, information for: identifying a desired plan to be carried out (plan identification information); identifying processes for carrying out of the desired plan (process identification information); identifying resources (operator and/or apparatus) for processing the processes (resource identification information); showing a sequence of the processes to be processed (process sequence information) and showing schedule (start date, end date, number of days for the processing, start time, end time, time period for the processing) (schedule information). In the present embodiments, the plan information 2a includes the plan identification information and the process sequence information, but the plan identification information and/or the process sequence information are not necessarily included.

Table 1 shows an example of the plan information 2a stored in the storage device 2. Table 1 shows a schedule for carrying out a plan identified by plan identification information O1 and a plan identified by plan identification information O2. In Table 1, the process sequence is represented by integers starting with 1. However, the representation of the process sequence is not limited to this, and information showing dependencies of processes, such as process identification information showing a pre-process and a post-process, may be registered as the process sequence.

TABLE 1

| Plan | Process | Process | Resource | | |
|---|---|---|---|---|---|
| identification | identification | sequence | identification | Start | End |
| information | information | information | information | time | time |
| O1 | F11 | 1 | M1 | 8:30 | 9:00 |
| O1 | F12 | 2 | M2 | 9:00 | 10:00 |
| O1 | F13 | 3 | M3 | 10:00 | 10:30 |
| O2 | F21 | 1 | M1 | 9:00 | 9:30 |
| O2 | F22 | 2 | M2 | 10:00 | 11:00 |

### About the Plan Identified by the Plan Identification Information O1

The plan identified by the plan identification information O1 includes processes identified by process identification information F11, F12 and F13. The process identification information F11 identifies a process to be processed by the resource identified by the resource identification information M1, with a start time of 8:30 and an end time of 9:00. The process identification information F12 identifies a process to be processed by the resource identified by the resource identification information M2, with a start time of 9:00 and an end time of 10:00. The process identification information F13 identifies a process to be processed by the resource identified by the resource identification information M3, with a start time of 10:00 and an end time of 10:30.

### About the Plan Identified by the Plan Identification Information O2

The plan identified by the plan identification information O2 includes processes identified by process identification information F21 and F22. The process identification information F21 identifies a process to be processed by the resource identified by the resource identification information M1, with a start time of 9:00 and an end time of 9:30. The process identification information F22 identifies a process to be processed by the resource identified by the resource identification information M2, with a start time of 10:00 and an end time of 11:00.

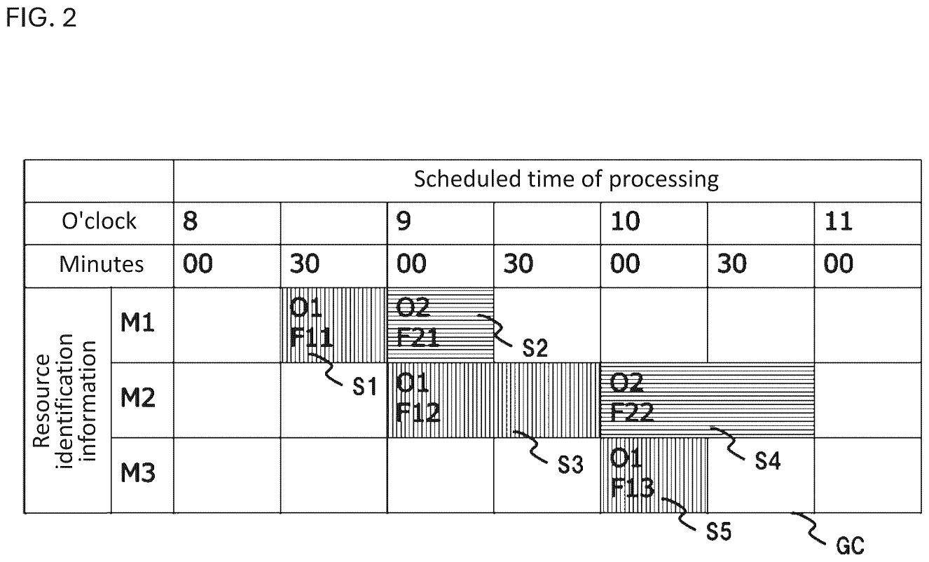

FIG. 2 shows an example of a Gantt chart generated by the Gantt chart generation unit 112 on the basis of the plan information 2a shown in Table 1.

On the basis of the plan information 2a acquired by the acquisition unit 111, the Gantt chart generation unit 112 generates a Gantt chart showing, for each of resources and time periods, the processes to be processed by the resources in the time periods shown in the plan information 2a. Specifically, as shown in FIG. 2, the Gantt chart generation unit 112 generates a Gantt chart GC showing the resource identification information identifying the resources for processing the processes on the vertical axis and scheduled processing times (start time and end time) of the processes on the horizontal axis. The Gantt chart generation unit 112 generates schedule images S1 to S5 on which the process identification information and/or the plan identification information are displayed by texts. In addition, the Gantt chart generation unit 112 may differentiate the schedule images S1 to S5 by display modes of color and/or hatching, etc., for each of the processes identified by the process identification information. The Gantt chart generation unit 112 may generate the schedule images S1 to S5 of a shape, for example, rectangular, linear, or arrow. The Gantt chart generation unit 112 then aligns the schedule images S1 to S5 with the scheduled processing times.

### About the Change Information 2b Stored in the Storage Device 2

The change information 2b is information showing, for each of time periods, variable quantities in accordance with the processes processed by the resources and is information that is expected to affect the carrying out of the desired plan.

In addition to the information for identifying resources such as an operator and/or an apparatus (the resource identification information), the change information 2b includes, but not limited to, information for: showing scheduled operating time of the resources (operation schedule information); showing scheduled stock quantity of materials to be consumed by the resources (scheduled stock information); showing cumulative numbers of scheduled uses of materials to be used by the resources (scheduled usage information); showing scheduled power consumption by the resources (scheduled power consumption information); showing scheduled water consumption by the resources (scheduled water consumption information); and showing scheduled carbon dioxide emissions by the resources (scheduled carbon dioxide emissions information). The change information 2b may also include values (an upper limit value and a lower limit value) determined as reference values for the operation schedule information showing the operating time, the scheduled usage information, the scheduled power consumption, the scheduled water consumption, and/or the scheduled carbon dioxide emissions. The management system 100 may have more than one storage device 2.

Table 2 show an example of the change information 2b stored in the storage device 2. Table 2 shows, in time series, a cumulative number of a material scheduled to be used (for example, a jig) by the resource identified by the resource identification information M2, and the upper limit value of the cumulative number.

TABLE 2

| Resource identification | | Cumulative | |
|---|---|---|---|
| information | Time | number of uses | Upper limit value |
| M2 | 8:00 | 0 | 5 |
| | 8:30 | 0 | 5 |
| | 9:00 | 1 | 5 |
| | 9:30 | 1 | 5 |
| | 10:00 | 2 | 5 |
| | 10:30 | 2 | 5 |

The change information 2b in Table 2 shows a schedule in which the cumulative number of uses of a jig by the resource identified by the resource identification information M2 changes from 0 times in a period from 8:00 to just before 9:00, 1 time in a period from 9:00 to just before 10:00, to 2 times in a period after 10:00. Also, the change information 2b in Table 2 shows that the upper limit value of the cumulative number of scheduled uses of the jig by the resource identified by the resource identification information M2 is 5.

On the basis of the change information 2b acquired by the acquisition unit 111, the change image generation unit 115 generates change images which show, for each of resources and time periods, quantities changing in time series in accordance with the processes processed by the resources. Specifically, the change image generation unit 115 generates change images with the minimum value or the lower limit value included in the change information 2b acquired by the acquisition unit 111 set as the lower ends of the change images and the maximum value or the upper limit value included in the change information 2b acquired by the acquisition unit 111 set as the upper ends of the change images. The superimposition unit 113 superimposes the change images generated by the change image generation unit 115 on the corresponding areas to the resources and the time periods on the Gantt chart generated by the Gantt chart generation unit 112.

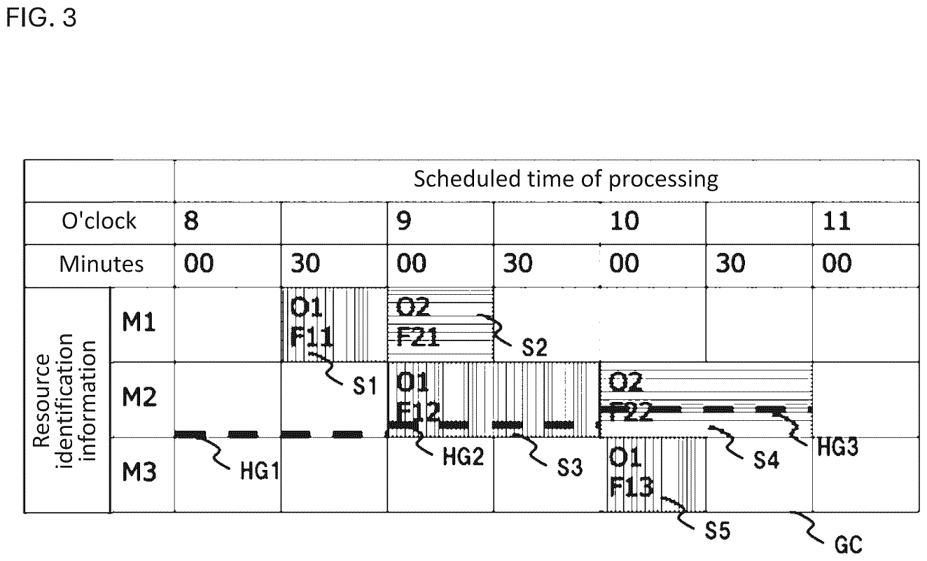

FIG. 3 shows an example of a Gantt chart with the superimposed change images generated by the Gantt chart generation unit on the basis of the change information 2b in Table 2. FIG. 3 shows an example in which, on the basis of the change information 2b shown in Table 2, the change image generation unit 115 generates a change image HG1 showing 0 times in a period from 8:00 to just before 9:00, a change image HG2 showing 1 time in a period from 9:00 to just before 10:00, and a change image HG3 showing 2 times in a period after 10:00, on a coordinate system with the lower end of the axis corresponding to the resource identification information M2 set as 0 times, which is the minimum value, and the upper end of the same axis set as 5 times, which is the upper limit value. The change image generation unit 115 may include, in the change images, texts of a numeric value showing the lower end (for example, 0 times) on the axis corresponding to the resource identification information M2 and/or a numeric value showing the upper end (for example, 5 times) on the same axis.

Meanwhile, when the change information 2b shows information that is cumulatively additive, such as the operation schedule information showing the operating time, the scheduled power consumption, the scheduled water consumption, and the scheduled carbon dioxide emissions, then the change image generation unit 115 should generate change images similar to those generated in the case where the change information 2b shows the usage information showing the cumulative number of scheduled uses (FIG. 3). When the change information 2b shows information regarding a number/amount that increases or decreases in time series, such as an inventory schedule, the change image generation unit 115 should generate change images with the lower limit value of the scheduled stock quantity set as the lower end and the upper limit value of the scheduled stock quantity set as the upper end. In FIG. 3, the change image generation unit 115 generated the change images as a bar graph, but may instead generate change images of a shape other than a bar graph, such as a sequential line graph. The change image generation unit 115 may also generate change images in which the numeric values indicated by the change information are represented by texts. When the numeric values indicated by the change information exceed the upper limit value or the lower limit value, the change image generation unit 115 may generate change images of a display mode (color, shape) different from that when the numeric values indicated by the change information do not exceed the upper limit value or the lower limit value.

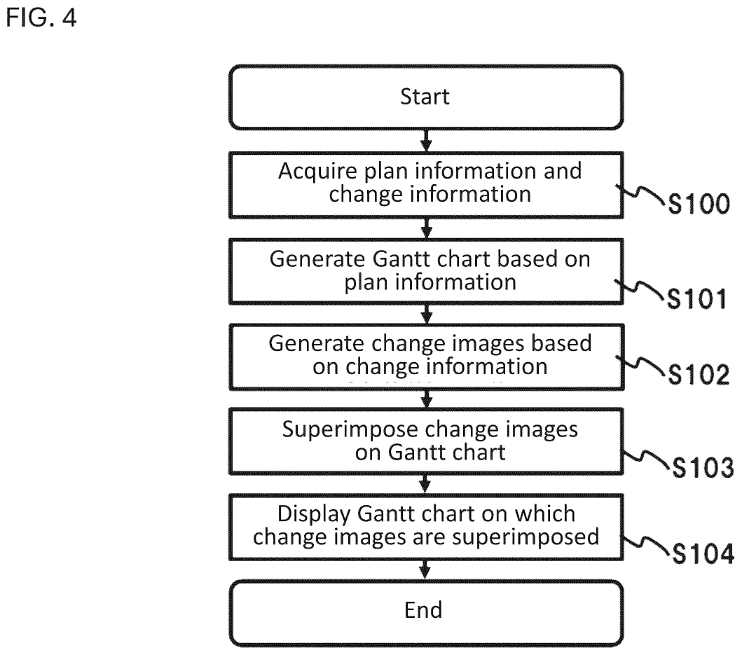

FIG. 4 is a flowchart diagram showing the operation of the Gantt chart generation device 1.

The acquisition unit 111 of the Gantt chart generation device 1 acquires the plan information 2a and the change information 2b from the storage device 2 (Step S100). The Gantt chart generation unit 112 generates a Gantt chart based on the plan information 2a acquired by the acquisition unit 111 (Step S101). The change image generation unit 115 generates change images based on the change information 2b acquired by the acquisition unit 111 (S102). The superimposition unit 113 superimposes the change images generated by the change image generation unit 115 on the Gantt chart generated by the Gantt chart generation unit 112 (Step S103). The display control unit 114 displays on the display device 3 the Gantt chart on which the change images are superimposed by the superimposition unit 113 (Step S104).

The Gantt chart generation device 1 according to the present disclosure displays not only a Gantt chart generated on the basis of the plan information 2a, but also a Gantt chart on which the change images generated on the basis of the change information 2b are superimposed. This allows the operator to create and/or modify Gantt charts with reference to the change images. Thus, the Gantt chart generation device 1 according to the present disclosure can reduce the cumbersomeness with the work of creating and/or modifying the Gantt charts.

Meanwhile, the change image generation unit 115 may generate change images corresponding to a variety of schedule information changing in time series regarding the resources (for example, the cumulative number of scheduled uses and the operation schedule), instead of change images corresponding to only one type of schedule information changing in time series regarding the resources (for example, the cumulative number of uses). The superimposition unit 113 may then superimpose the variety of change images generated by the change image generation unit 115 on the Gantt chart generated by the Gantt chart generation unit 112. In this case, the superimposition unit 113 may superimpose the variety of change images at the same time, or may be configured to prompt the operator to select which of the variety of change images to superimpose. These mode arrangements allow the operator to create and/or modify a Gantt chart with reference to the change images corresponding to the variety of change information. Thus, the Gantt chart generation device 1 according to the present disclosure can reduce the cumbersomeness with the work of creating and/or modifying a Gantt chart as compared to the case in which a Gantt chart is created/modified with reference to the change images corresponding to only one type of change information.

### Embodiment 2

According to Embodiment 1, the Gantt chart generation device 1 superimposed the change images generated on the basis of the change information 2b on the Gantt chart generated on the basis of the plan information 2a, thereby reducing the cumbersomeness for the operator with the work of creating and/or modifying a Gantt chart. However, images which may be superimposed on a Gantt chart by the Gantt chart generation device 1 are not limited to those described above. For example, the Gantt chart generation device 1 may superimpose on a Gantt chart, on the basis of the schedule information 2a, images showing time-series transition in numbers of processes to be processed by the resources and/or in numbers of processes scheduled to be backlogged by the resources.

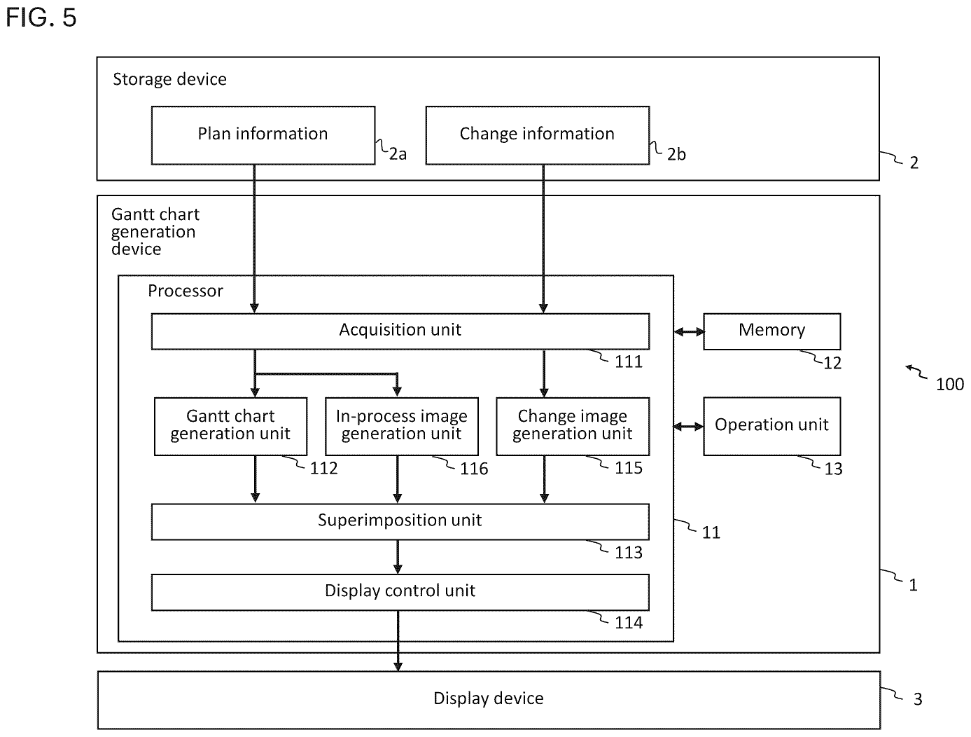

FIG. 5 shows an example of a management system 100 including a Gantt chart generation device 1 according to Embodiment 2. The Gantt chart generation device 1 according to Embodiment 2 differs in that it includes an in-process image generation unit 116 in addition to the functional configurations according to Embodiment 1. The processor 11 performs the functions of the acquisition unit 111, the Gantt chart generation unit 112, the change image generation unit 115, the in-process image generation unit 116, the superimposition unit 113, and the display control unit 114 by executing a program. The in-process image generation unit 116 generates in-process images showing time-series transition in numbers of processes scheduled to be processed by the resources and/or in numbers of processes scheduled to be backlogged by the resources on the basis of the plan information 2a. The superimposition unit 113 superimposes the change images generated by the change image generation unit 115 and the in-process images generated by the in-process image generation unit 116 on the corresponding areas to the resources and the time periods on a Gantt chart generated by the Gantt chart generation unit 112. The display control unit 114 displays, on the display device 3, the Gantt chart on which the change images and the in-process images are superimposed by the superimposition unit 113.

Here, the term “processes scheduled to be processed” means the processes that are planned (scheduled) to be processed by a certain resource. The term “number of processes scheduled to be processed” means the number of unfinished processes among those planned (or scheduled) to be processed by a certain resource at a certain time. For example, the in-process image generation unit 116 counts the numbers of processes scheduled to be processed for each resource for each time included in the plan information 2a shown in Table 1 to determine time-series transition of numbers of processes scheduled to be processed for each resource. Table 3 shows an example of the time-series transition in numbers of processes scheduled to be processed for each resource, specified by the in-process image generation unit 116. Table 3 shows the numbers of processes scheduled to be processed for each time in accordance with the resource identification information.

TABLE 3

| | | Numbers of processes scheduled to be processed | | | | | | |
|---|---|---|---|---|---|---|---|---|
| | | for each time | | | | | | |
| | | 8:00 | 8:30 | 9:00 | 9:30 | 10:00 | 10:30 | 11:00 |
| Resource | M1 | 2 | 2 | 1 | 0 | 0 | 0 | 0 |
| identification | M2 | 2 | 2 | 2 | 2 | 1 | 1 | 0 |
| information | M3 | 1 | 1 | 1 | 1 | 1 | 0 | 0 |

The term “processes scheduled to be backlogged” means processes which are scheduled not to be processed even after a threshold time (for example, 5 minutes) after the processing of the pre-process has been finished. For example, as shown in FIG. 2 of Embodiment 1, in the plan identified by the plan identification information O2, the end time of processing the process identified by the process identification information F21 (pre-process) is at 9:30, but the start time of the processing the process identified by the process identification information F22 (post-process) is at 10:00, which is after the threshold time (for example, 5 minutes) has elapsed. This is because the resource (identified by the resource identification information M2), which is scheduled to process the process identified by the process identification information F22 in the plan identification information O2, is still processing the process identified by the process identification information F12 in the plan identification information O1, which was started earlier. A process which is scheduled not to be started even after a threshold time or more has elapsed after the pre-process has been finished, such as this process identified by the process identification information F22 described above, is referred to as a process scheduled to be backlogged. Note, however, that for a process which does not have a pre-process (for example, the process identified by the process identification information F21 in the plan identification information O2 shown in FIG. 2), it cannot be determined whether the start of its processing is delayed or not, so that such a process is excluded from the processes scheduled to be backlogged.

The in-process image generation unit 116 refers to the plan information 2a and identifies a process, specified by the process identification information, which is relevant to the case where the end time of the pre-process and the start time of the post-process differ by more than a threshold time, from among the multiple processes specified by the process identification information included in the same plan identification information. The in-process image generation unit 116 then determines the resource identification information of the identified resource that processes the process of the process identification information, and the start time and the end time of the identified process of the process identification information. Table 4 shows time-series transition in numbers of processes scheduled to be backlogged for each resource. Table 4 shows the numbers of processes scheduled to be backlogged for each time in accordance with the resource identification information.

TABLE 4

| | | Numbers of processes scheduled to be backlogged | | | | | | |
|---|---|---|---|---|---|---|---|---|
| | | for each time of processing scheduled | | | | | | |
| | | 8:00 | 8:30 | 9:00 | 9:30 | 10:00 | 10:30 | 11:00 |
| Resource | M1 | — | — | — | — | — | — | — |
| identification | M2 | 0 | 0 | 0 | 1 | 0 | 0 | 0 |
| information | M3 | 0 | 0 | 0 | 0 | 0 | 0 | 0 |

On the basis of the plan information 2a acquired by the acquisition unit 111, the in-process image generation unit 116 generates the in-process images showing the numbers of processes scheduled to be processed and/or the numbers of processes scheduled to be backlogged. The superimposition unit 113 then superimposes the in-process images generated by the in-process image generation unit 116 on the corresponding areas to the resource identification information and the times on the Gantt chart.

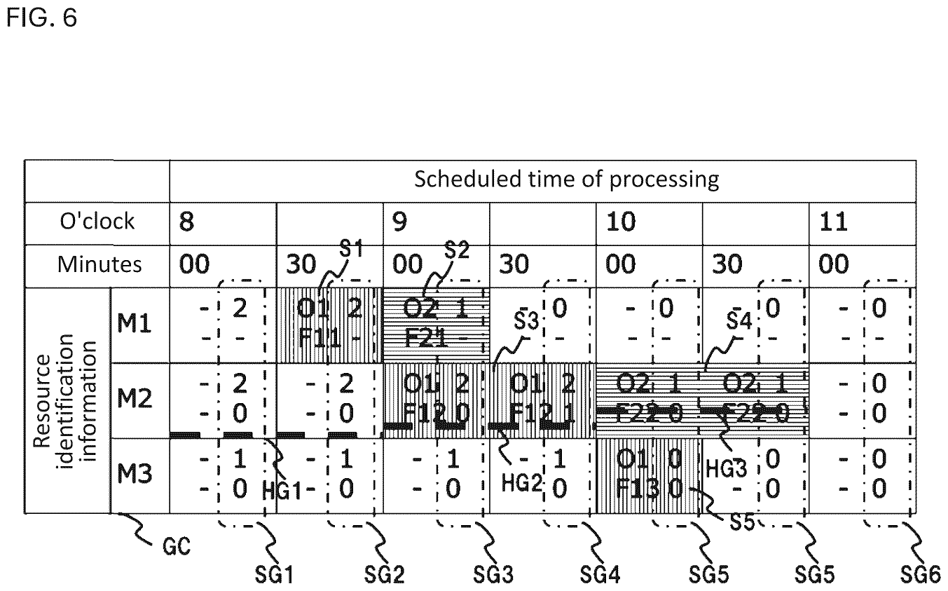

FIG. 6 shows an example of a Gantt chart on which in-process images SG1 to SG6 are superimposed, the in-process images SG1 to SG6 being generated on the basis of the numbers of processes scheduled to be processed for the resources in Table 3 and the numbers of the processes scheduled to be backlogged for the same resources in Table 4. In FIG. 6, the in-process images SG1 to SG6 show in the upper right quadrant of each cell a text representing the number of processes scheduled to be processed for the resources in Table 3, and in the lower right quadrant a text representing the number of processes scheduled to be backlogged in Table 4.

Not being limited to this display mode described above, the in-process image generation unit 116 may generate the in-process images showing time-series transition in numbers of processes scheduled to be processed for the resources on a coordinate system with the minimum value of the numbers of processes scheduled to be processed for the resources set as the lower end and the maximum value thereof set as the upper end, as in the change images HG1 to HG3. Similarly, the in-process image generation unit 116 may generate the in-process images showing time-series transition in numbers of the processes scheduled to be backlogged on a coordinate system with the minimum value of the numbers of the processes scheduled to be backlogged set as the lower end and the maximum value thereof set as the upper end, as in the change images HG1 to HG3.

When an upper limit value and/or a lower limit value is predetermined for the numbers of processes scheduled to be processed and it is detected that the upper limit value and/or the lower limit value will be exceeded, the in-process image generation unit 116 may generate in-process images differentiated by text color, font, text size, etc.

When an upper limit value and/or a lower limit value is predetermined for the numbers of processes scheduled to be backlogged and it is detected that the upper limit value and/or the lower limit value will be exceeded, the in-process image generation unit 116 may generate in-process images differentiated by text color, font, text size, etc.

### Embodiment 3

In Embodiments 1 and 2, the Gantt chart generation device 1 superimposes the change images generated on the basis of the change information 2b on the Gantt chart generated on the basis of the plan information 2a. However, in addition to the images showing schedules, such as the plan information 2a and the change information 2b, the Gantt chart generation device 1 may superimpose images showing actual numbers on a Gantt chart.

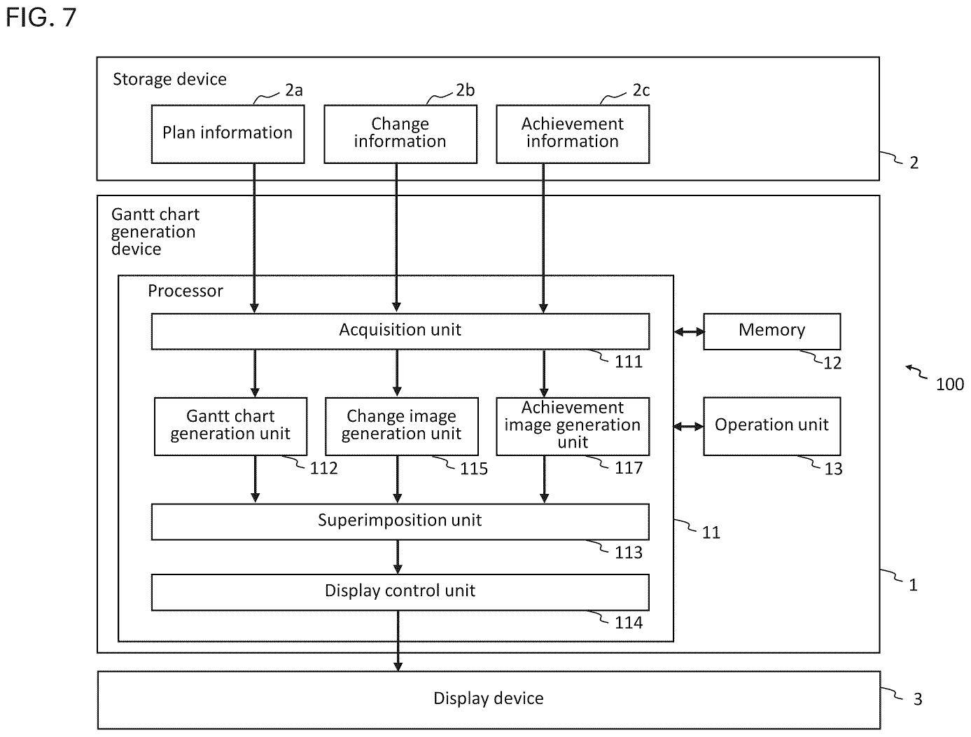

FIG. 7 shows an example of the management system 100 including a Gantt chart generation device 1 according to Embodiment 3. The Gantt chart generation device 1 according to Embodiment 3 differs in that it includes an achievement image generation unit 117 in addition to the functional configurations shown in Embodiment 2. The processor 11 performs the functions of the acquisition unit 111, the Gantt chart generation unit 112, the change image generation unit 115, the achievement image generation unit 117, the superimposition unit 113, and the display control unit 114 by executing a program. The acquisition unit 111 acquires achievement information 2c in addition to the plan information 2a and the change information 2b. The achievement information 2c is information showing, for each of time periods, actual numbers of the processes finished by resources, actual numbers of the processes backlogged by resources, and/or quantities changed in accordance with processing of resources, including the actual numbers corresponding to the change information 2b described in Embodiment 1. On the basis of the achievement information 2c acquired by the acquisition unit 111, the achievement image generation unit 117 generates achievement images showing, for each of resources and time periods, the quantities changed in accordance with the processing of the resources. The superimposition unit 113 superimposes the change images generated by the change image generation unit 115 and the achievement images generated by the achievement image generation unit 117 on a Gantt chart generated by the Gantt chart generation unit 112. The display control unit 114 displays, on the display device 3, the Gantt chart with the change images and the achievement images superimposed by the superimposition unit 113.

### The Achievement Images Showing Time-Series Transition in Numbers of the Processes Backlogged by the Resources

The achievement information 2c in Table 5 shows time-series transition in actual numbers of the processes backlogged by the resources. The achievement information 2c in Table 5 shows that the resource identified by the resource identification information M2 backlogged 0 process after 8:00 and just before 10:00, one process after 10:00 and just before 10:30, and 0 process after 10:30.

TABLE 5

| Resource identification | | Number of processes |
|---|---|---|
| information | Time | backlogged |
| M2 | 8:00 | 0 |
| | 8:30 | 0 |
| | 9:00 | 0 |
| | 9:30 | 0 |
| | 10:00 | 1 |
| | 10:30 | 0 |
| | 11:00 | 0 |

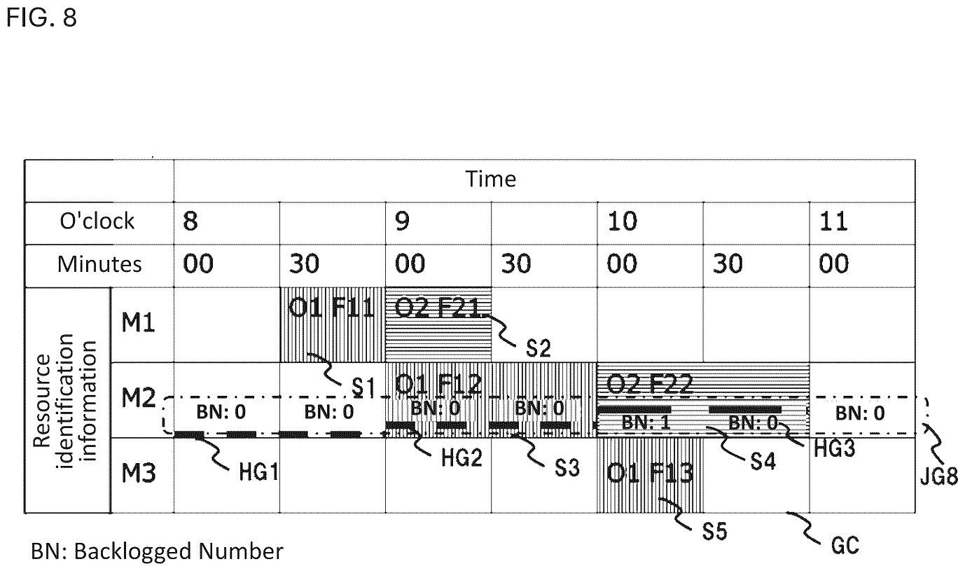

FIG. 8 shows an example of a Gantt chart on which an achievement image is superimposed, the achievement image being generated on the basis of the achievement information 2c and showing the numbers of the processes backlogged in Table 5. In FIG. 8, the achievement image JG8 shows in the lower half of each cell the actual number of the processes backlogged by the resource identified by the resource identification information M2 in Table 5. By referring to FIG. 8, the operator can visually understand that the processing of the process identified by the process identification information F22 in the plan identification information O2, which was originally scheduled to start at 10:00 according to the schedule image S4, was backlogged (delayed), but the backlog was resolved at the stage of 10:30.

The achievement image generation unit 117 may generate the achievement images with an initial value, the minimum value, or the lower limit value included in the achievement information 2c acquired by the acquisition unit 111 set as the lower end, and with the initial value, the maximum value, or the upper limit value included in the achievement information 2c set as the upper end.

### The Achievement Images Showing Time-Series Transition in Numbers of the Processes Finished by the Resources

The achievement information 2c in Table 6 shows time-series transition in actual numbers of the processes finished by the resource. The achievement information 2c in Table 6 shows that the resource identified by the resource identification information M2 finished 0 process after 8:00 and just before 10:00, one process after 10:00 and just before 11:30, and 2 processes after 11:30.

TABLE 6

| Resource identification | | Number of processes |
|---|---|---|
| information | Time | finished |
| M2 | 8:00 | 0 |
| | 8:30 | 0 |
| | 9:00 | 0 |
| | 9:30 | 0 |
| | 10:00 | 1 |
| | 10:30 | 1 |
| | 11:00 | 1 |
| | 11:30 | 2 |

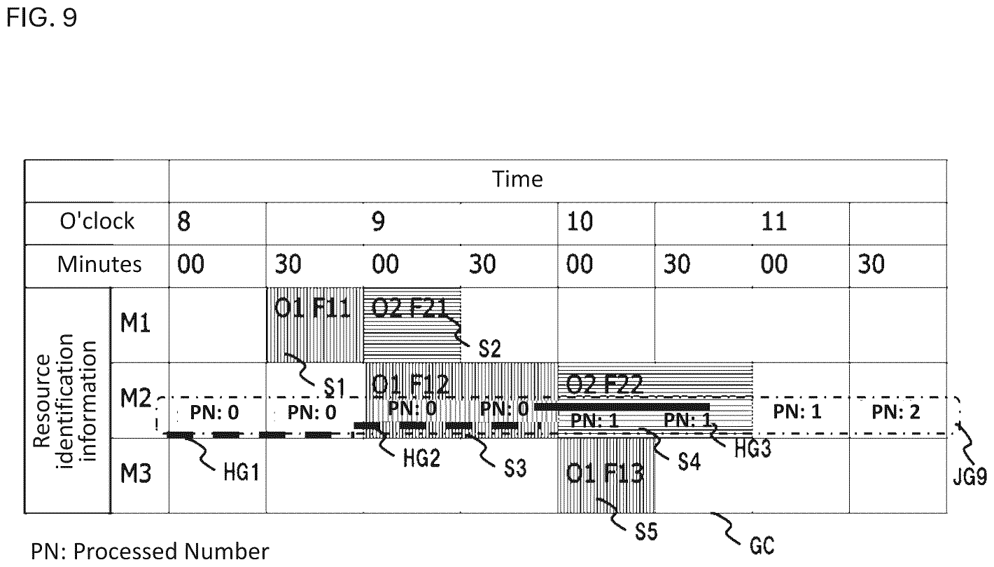

FIG. 9 shows an example of a Gantt chart on which an achievement image is superimposed, the achievement image being generated on the basis of the achievement information 2c and showing the numbers of processes finished in Table 6. In FIG. 9, the achievement image JG9 shows in the lower half of each cell the actual number of the processes finished by the resource identified by the resource identification information M2 in Table 6. By referring to FIG. 9, the operator can visually understand that the processing of the process identified by the process identification information F22 in the plan identification information O2, which was originally scheduled to be finished before 11:00 according to the schedule image S4, was delayed, but the processing was finished at the stage of 11:30.

The achievement image generation unit 117 may generate the achievement images with an initial value, the minimum value, or the lower limit value included in the achievement information 2c acquired by the acquisition unit 111 set as the lower end, and with the initial value, the maximum value, or the upper limit value included in the achievement information 2c set as the upper end.

### The Achievement Images Showing Time-Series Transition in Actual Numbers Corresponding to the Change Information 2b

The achievement information 2c in Table 7 shows time-series transition of a cumulative number of uses (actual numbers) of a material (for example, a jig) by a resource. The achievement information 2c in Table 7 shows that the actual cumulative number of uses by the resource identified by the resource identification information M2 is 0 after 8:00 and just before 9:00, 1 after 9:00 and just before 10:30, and 2 after 10:30.

TABLE 7

| Resource identification | | Cumulative |
|---|---|---|
| information | Time | number of uses |
| M2 | 8:00 | 0 |
| | 8:30 | 0 |
| | 9:00 | 1 |
| | 9:30 | 1 |
| | 10:00 | 1 |
| | 10:30 | 2 |
| | 11:00 | 2 |

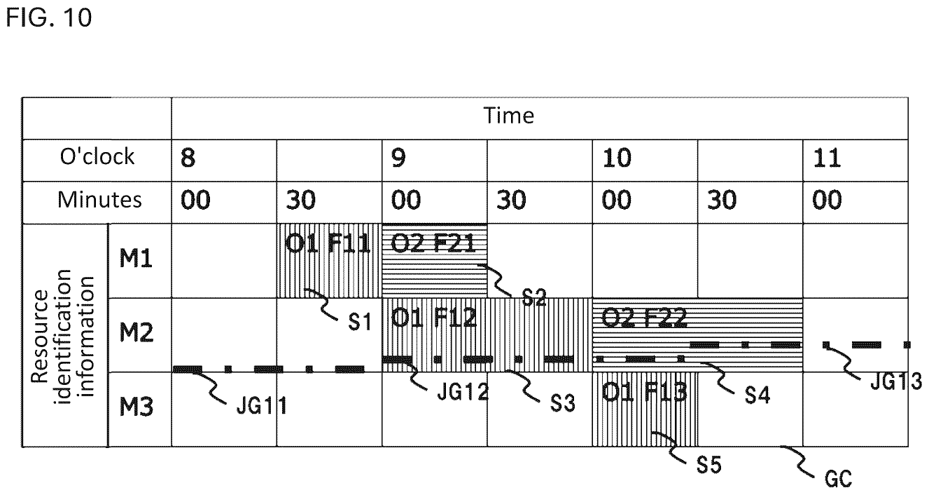

FIG. 10 shows an example of a Gantt chart on which the achievement images are superimposed, the achievement images being generated on the basis of achievement information corresponding to the change information 2b in Table 7. In FIG. 10, the change images are omitted for illustrative purposes. The achievement image generation unit 117 generates the achievement images with an initial value, the minimum value, or the lower limit value included in the achievement information 2c acquired by the acquisition unit 111 set as the lower end, and with the initial value, the maximum value, or the upper limit value included in the achievement information 2c set as the upper end. When the achievement images and the change images are superimposed on the same Gantt chart, the achievement image generation unit 117 generates the achievement images and the change images with different display modes (for example, color, line segment). When the achievement images and the change images are superimposed on the same Gantt chart, the achievement image generation unit 117 generates the achievement images with the values of the lower end and the upper end in the horizontal axis made equal to those in the coordinate system shown by the change images. In FIG. 10, it is assumed that the upper limit value is set as 5 times as in Embodiment 1.

On the basis of the achievement information 2c in Table 7, the achievement image generation unit 117 generates the achievement images JG11 to JG13 showing that the cumulative numbers of uses are 0 times for the period after 8:30 and just before 9:00, 1 time for the period after 9:00 and just before 10:30, and 2 times for the period after 10:30 on the coordinate system corresponding to the resource identification information M2 and having the horizontal axis with the lower end set as 0 times and the upper end set as 5 times. The operator can modify a Gantt chart after understanding the actual numbers by referring to the achievement images JG11 to JG13, so that the cumbersomeness for the operator with the work of creating and/or modifying a Gantt chart is reduced.

The Gantt chart generation device 1 according to the present disclosure superimposes the change images generated on the basis of the change information 2b and the achievement images generated on the basis of the achievement information 2c on a Gantt chart generated on the basis of the plan information 2a. This allows the operator to create and/or modify the Gantt chart with reference to the change images and the achievement images. Thus, the Gantt chart generation device 1 according to the present disclosure can reduce the cumbersomeness with the work of creating and/or modifying the Gantt charts.

Besides, the achievement image generation unit 117 may generate a variety of achievement images instead of only one type of achievement images. In this case, the achievement image generation unit 117 may differentiate the achievement images by color and/or hatching, etc., so that each of the variety of achievement images can be identified. Further, the achievement image generation unit 117 may generate the achievement images different from the change images by color and/or hatching, etc., so that they can be distinguished from the change images generated by the change image generation unit 115. Also, the superimposition unit 113 may superimpose, on a Gantt chart generated by the Gantt chart generation unit 112, only one type of achievement images or the variety of achievement images generated by the achievement image generation unit 117. In this case, the superimposition unit 113 may superimpose the variety of achievement images at the same time, or may be configured to prompt the operator to select which of the variety of achievement images to superimpose. These mode arrangements allow the operator to create and/or modify a Gantt chart with reference to only one type of or to the variety of achievement images. Thus, the Gantt chart generation device 1 according to the present disclosure can reduce the cumbersomeness with the work of creating and/or modifying the Gantt charts.

The processes performed by the Gantt chart generation device 1 described above may be provided as a program and/or a method for making a computer function as such.

### DESCRIPTION OF SYMBOLS

1 . . . Gantt chart generation device,
11 . . . processor,
111 . . . acquisition unit,
112 . . . Gantt chart generation unit,
113 . . . superimposition unit,
114 . . . display control unit,
115 . . . change image generation unit,
116 . . . in-process image generation unit,
117 . . . achievement image generation unit,
2 . . . storage device,
2a . . . plan information,
2b . . . change information,
2c . . . achievement information,
3 . . . display device,
12 . . . memory,
13 . . . operation unit

1. A Gantt chart generation device comprising:
a processor to execute a program; and
a memory to store the program which, when executed by the processor, performs processes of,
acquiring plan information showing processes for carrying out a desired plan, resources for processing the processes, and time periods for processing the processes, and change information showing quantities changing in accordance with the processing of the resources for each of the time periods, the change information being to affect the carrying out of the desired plan;
generating a Gantt chart showing, for each of the resources and the time periods, the processes processed by the resource in the time period on a basis of the plan information;
generating change images showing, for each of the resources and the time periods, the quantities changing in accordance with the processing of the resources on a basis of the change information;
superimposing the change images on corresponding areas to the resources and the time periods on the Gantt chart; and
displaying the Gantt chart on which the change images are superimposed on a display device, wherein the change information shows scheduled carbon dioxide emissions of the resources, scheduled power consumption of the resources, or scheduled water consumption of the resources.

2. The Gantt chart generation device according to claim 1, wherein the change images are generated with a minimum value or a lower limit value of the quantities shown by the change information set as a lower end and a maximum value or an upper limit value of the quantities shown by the change information set as an upper end.

3. The Gantt chart generation device according to claim 1, wherein the change information further includes information which shows scheduled operating times of the resources, scheduled stock quantities of materials to be consumed by the resources, or cumulative numbers of scheduled uses of materials to be used by the resources.

4. The Gantt chart generation device according to claim 1, wherein in-process images showing, for each of the resources and the time periods, numbers of processes scheduled to be processed or numbers of processes scheduled to be backlogged are further generated on a basis of the plan information and the in-process images are superimposed on corresponding areas to the resources and the time periods on the Gantt chart.

5. The Gantt chart generation device according to claim 1,
wherein achievement information showing, for each of the time periods, the quantities changed in accordance with the processing of the resources including actual quantities corresponding to the change information is acquired,
wherein achievement images showing, for each of the resources and the time periods, the quantities changed in accordance with the processing of the resources on are generated a basis of the achievement information, and
wherein the achievement images are superimposed on corresponding areas to the resources and the time periods on the Gantt chart.

6. A medium storing a program for causing a computer to perform processes of:
acquiring plan information showing processes for carrying out a desired plan, resources for processing the processes, and time periods for processing the processes, and change information showing quantities changing in accordance with the processing of the resources for each of the time periods, the change information affecting the carrying out of the desired plan;
generating a Gantt chart showing, for each of the resources and the time periods, the processes processed by the resources in the time periods on a basis of the acquired plan information;
generating change images showing, for each of the resources and the time periods, the quantities changing in accordance with the processing of the resources on a basis of the acquired change information;
superimposing the generated change images on corresponding areas to the resources and the time periods on the Gantt chart; and
displaying, on a display device, the Gantt chart on which the change images are superimposed,
wherein the change information shows scheduled carbon dioxide emissions of the resources, scheduled power consumption of the resources, or scheduled water consumption of the resources.

7. A Gantt chart generation method for causing a computer to perform processes of:
acquiring plan information showing processes for carrying out a desired plan, resources for processing the processes, and time periods for processing the processes, and change information showing quantities changing in accordance with the processing of the resources for each of the time periods, the change information affecting the carrying out of the desired plan;
generating a Gantt chart showing, for each of the resources and the time periods, the processes processed by the resources in the time periods on a basis of the acquired plan information;
generating change images showing, for each of the resources and the time periods, the quantities changing in accordance with the processing of the resources on a basis of the acquired change information;
superimposing the generated change images on corresponding areas to the resources and the time periods on the Gantt chart; and
displaying, on a display device, the Gantt chart on which the change images are superimposed,
wherein the change information shows scheduled carbon dioxide emissions of the resources, scheduled power consumption of the resources, or scheduled water consumption of the resources.
